(19) United States
(12) Patent Application Publication
(10) Pub. No.: US 2024/0301672 A1
(43) Pub. Date: Sep. 12, 2024

(54) Sprayer Attachment with Faucet Sleeve

(71) Applicant: Tasha Williams, Sacramento, CA (US)

(72) Inventor: Tasha Williams, Sacramento, CA (US)

(21) Appl. No.: 18/117,647

(22) Filed: Mar. 6, 2023

(51) Int. Cl. E03C 1/086; F16L 37/48

(52) U.S. Cl. CPC E03C 1/086; F16L 37/48

(57) ABSTRACT

A sprayer attachment with a faucet sleeve for securing to a tub faucet. The sprayer attachment includes a hose having a spray head at a first end and a faucet attachment disposed at an opposing second end, wherein the faucet attachment can be inserted within or around a faucet opening to allow water to pass through the hose to the spray head. The faucet sleeve extends from the second end of the hose, wherein the sleeve is movable between a non-use configuration and an in-use configuration. In the non-use configuration, the sleeve is rolled towards the first end, exposing the faucet attachment. In the in-use configuration, the faucet attachment is inserted within or around the faucet opening and the sleeve is unrolled, concealing the faucet attachment. The sleeve is flexible and elastic to secure around a length of the faucet.

### BACKGROUND OF THE INVENTION

The present invention relates to sprayers. The present invention provides a sprayer attachment with a faucet sleeve for securing to a tub faucet.

Bathtubs with showers typically have a shower head fixed to the wall. Some shower heads have a spray head connected to a hose, giving the ability of the spray head to detach from shower head while connected to a hose to allow a person to have more control over the water direction. However, many people either do not have showers with detachable spray heads or have the inability to physically detach the sprayer from the shower head due to the elevated height of the shower fixture.

As a solution, devices have been created to allow a spray head to connect to other types of faucets rather than only a shower fixture. However, existing sprayer attachments simply use suction cups or a loose fitting over a faucet, which often results in the sprayer becoming dislodged or leak. These sprayers lack a secure and reliable method for attaching the sprayer to the faucet, making them ineffective for their intended use. Additionally, existing sprayer attachments have limited compatibility with different faucet designs, poor fit and stability, and the need for constant readjustment. In many cases, the attachments slip or leak, leading to water damage to the bathroom and inconvenience for the user.

The current invention solves these deficiencies by providing a sprayer attachment with a faucet sleeve. The faucet sleeve is designed to fit snugly around the faucet, allowing for a secure connection without the risk of leaking. Additionally, the faucet sleeve can be rolled up and stored when not in use, saving valuable counter space. This combination of a secure connection and convenient storage make the current invention a significant improvement over existing devices.

In light of the devices disclosed in the known art, it is submitted that the present invention substantially diverges in design elements and methods from the known art and consequently it is clear that there is a need in the art for an improvement for a sprayer attachment with faucet sleeve. In this regard the instant invention substantially fulfills these needs.

### SUMMARY OF THE INVENTION

In view of the foregoing disadvantages inherent in the known types of sprayer attachments now present in the known art, the present invention provides a sprayer attachment with faucet sleeve wherein the same can be utilized for securing a spray head to a tub faucet.

It is an objective of the present invention to provide a sprayer attachment comprising a hose having a spray head at a first end and a faucet attachment disposed at an opposing second end, wherein the faucet attachment is rigid and configured to be inserted within or around a faucet opening to allow water to pass through the hose to the spray head. A faucet sleeve extends from the second end of the hose, wherein the sleeve is movable between a non-use configuration and an in-use configuration. In the non-use configuration, the sleeve is rolled towards the first end, exposing the faucet attachment. In the in-use configuration, the faucet attachment is inserted within or around the faucet opening and the sleeve is unrolled, concealing the faucet attachment.

It is an objective of the present invention to provide a sprayer attachment wherein the faucet sleeve is flexible and elastic to secure around a length of the faucet.

It is another objective of the present invention to provide a sprayer attachment that is compatible with different faucet designs. The flexible and elastic faucet sleeve ensures a secure and stable fit, overcoming the limitations of existing systems that often slip or leak.

It is another objective of the present invention to provide a watertight seal provided by the faucet sleeve to eliminate the risk of leakage and water damage to a bathroom.

It is yet another objective of the present invention to improve the functionality of traditional bathtubs. The sprayer attachment provides additional water flow options, making it easier and more effective to clean and wash in the bathtub.

It is therefore an object of the present invention to provide a new and improved sprayer attachment that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

FIG. 1 shows a perspective view of an embodiment of the sprayer attachment with faucet sleeve.

FIG. 2 shows a cross-sectional view of the second end of an embodiment of the sprayer attachment with faucet sleeve, wherein the sleeve is in a non-use configuration.

FIG. 3 shows a cross-sectional view of the second end of an embodiment of the sprayer attachment with faucet sleeve, wherein the sleeve is in an in-use configuration.

FIG. 4 shows another perspective view of an embodiment of the sprayer attachment with faucet sleeve.

FIG. 5 shows a perspective view of an embodiment of the sprayer attachment with faucet sleeve in use.

### DETAILED DESCRIPTION OF THE INVENTION

Reference is made herein to the attached drawings. For the purposes of presenting a brief and clear description of the present invention, the preferred embodiment will be discussed as used for securing a sprayer attachment to a tub faucet with a faucet sleeve. The figures are intended for representative purposes only and should not be considered to be limiting in any respect.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

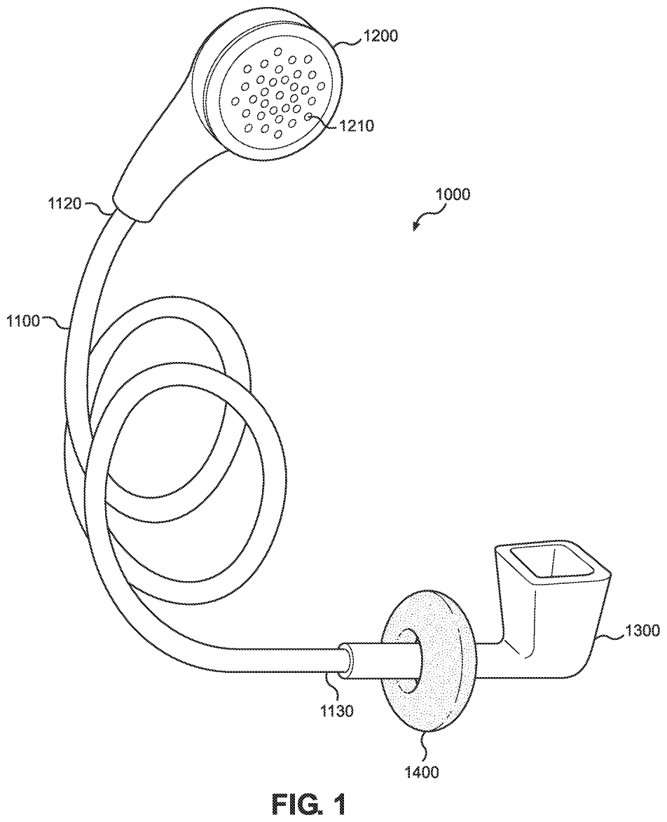

Referring now to FIG. 1, there is shown a perspective view of an embodiment of the sprayer attachment with faucet sleeve. The sprayer attachment 1000 attachment includes a hose 1100 having a spray head 1200 at a first end 1120 and a faucet attachment 1300 disposed at an opposing second end 1130. The faucet attachment 1300 is configured to be inserted within or around a faucet opening to allow water to pass through the hose 1100 to the spray head 1200. In the illustrated embodiment, the spray head 1200 is permanently secured to the hose 1100 and is adapted to be handheld. In alternate embodiments, the spray head is removably secured to the hose via a fastener, such as a friction fit, and interchangeable with a different type of spray head. The spray head comprises a plurality of apertures 1210 that allow fluid to flow from the hose and out of the spray head 1200. In some embodiments, the spray head 1200 comprises a plurality of settings that allow a user to adjust the flow rate of the water leaving the apertures 1210.

In the illustrated embodiment, the hose 1100 comprises a length between one to six feet. However, in alternate embodiments, the hose comprises any suitable length configured to extend within a bathtub. In the illustrated embodiment, the faucet attachment 1300 extends directly from the second end 1130 of the hose 1100. The hose 1100 is composed of a flexible material, such as vinyl, rubber, or polyurethane, wherein the faucet attachment 1300 is composed of a same material of the hose 1100 but more rigid in structure. In other embodiments, the hose and faucet attachment are composed of different types of material.

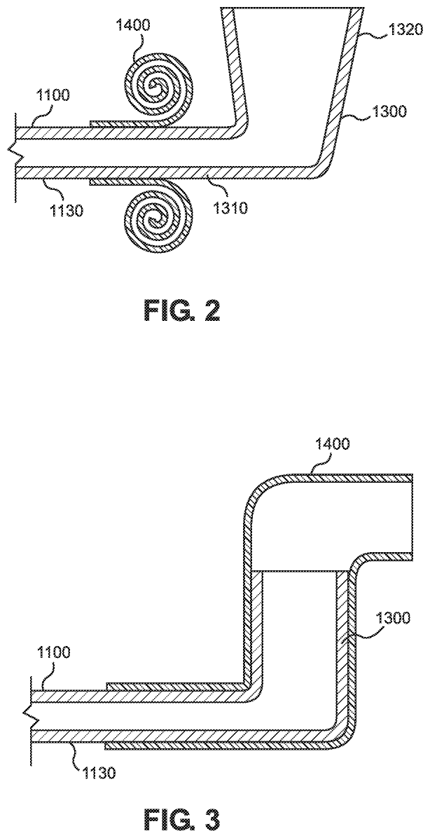

Referring now to FIGS. 2 and 3, there is shown a cross-sectional view of the second end of an embodiment of the sprayer attachment with faucet sleeve, wherein the sleeve is in a non-use configuration and an in-use configuration, respectively. The faucet attachment 1300 comprises a first end 1310 extending from the hose 1100 and a second end 1320 configured to attach to a tub faucet. In the illustrated embodiment, the first end 1310 of the faucet attachment is perpendicular to the second end 1320 thereof. A channel 1330 extends from the first end 1310 to the second end 1320 to allow water to flow therethrough. The second end 1320 is open and comprises a square cross-sectional shape. The square shape of the faucet attachment 1300 is adapted to correspond with a square shape of an opening of the tub faucet, wherein the second end 1320 of the faucet attachment is configured to be disposed around the tub faucet opening. In the embodiment shown in FIGS. 1 and 2, the faucet attachment 1300 tapers, narrowing in width, from the second end 1320 towards to the first end 1310 thereof. In alternate embodiments, such as seen in FIG. 3, second end 1320 of the faucet attachment 1300 comprises a uniform width. In other embodiments, the second end comprises any suitable shape configured to secure to a tub faucet.

A faucet sleeve 1400 extends from the second end 1130 of the hose 1100, wherein the sleeve 1400 is movable between a non-use configuration and an in-use configuration. In the non-use configuration, the sleeve 1400 is rolled towards the first end of the hose 1100, exposing the faucet attachment 1300. The sleeve 1400 is composed of an elastic and flexible material, such as neoprene, wherein the sleeve 1400 will return to its original shape after being stretched. In the illustrated embodiment, the sleeve 1400 is waterproof to prevent water from leaking through the sleeve when the faucet attachment is secured to the tub faucet. When rolled, the sleeve 1400 comprises a donut shape disposed around the hose 1100, as seen in FIGS. 1 and 2. The non-use configuration allows the faucet attachment 1300 to be secured to a tub faucet as needed.

In the in-use configuration, the sleeve 1400 is unrolled, concealing the faucet attachment 1300. The sleeve extends past the faucet attachment 1300 and configured to extend around a length of the tub faucet. The sleeve 1400 comprises a width that is smaller than a width of the faucet attachment 1300, such that the sleeve 1400 rests flush and tightly against the faucet attachment 1300 when unrolled therearound.

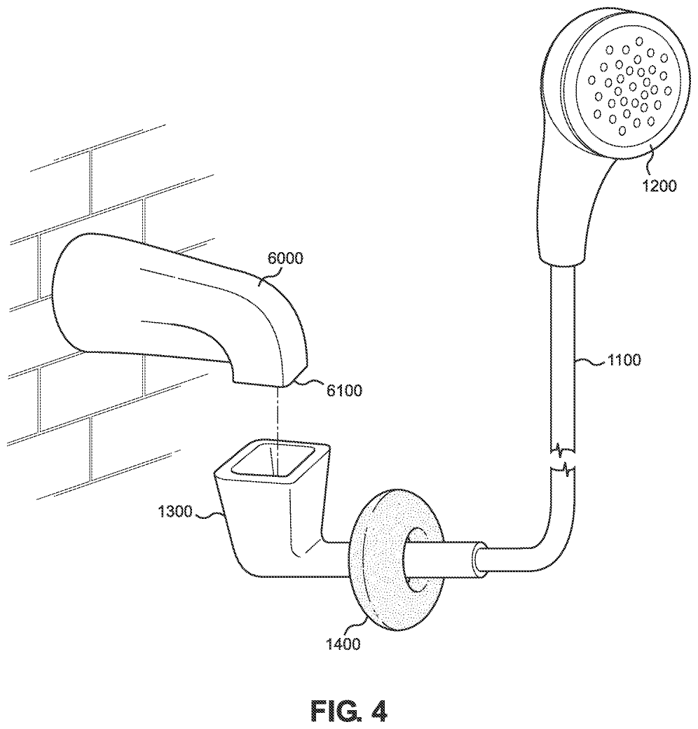

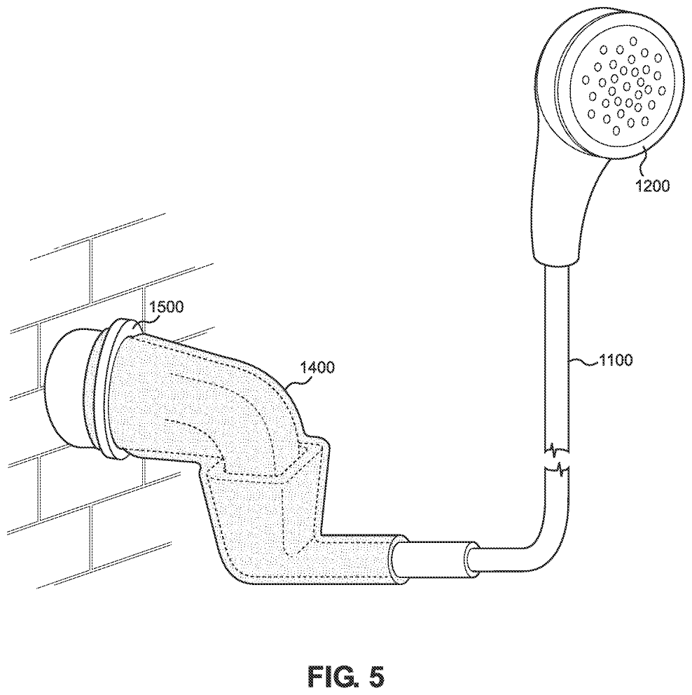

Referring now to FIGS. 4 and 5, there are shown perspective views of an embodiment of the sprayer attachment with faucet sleeve in use. In operation, the sleeve 1400 is rolled to the non-use configuration, exposing the faucet attachment 1300. Once exposed, the faucet attachment 1300 is secured to the tub faucet 6000 via a friction fit by positioning the faucet attachment around an opening 6100 of the tub faucet 6000. The sleeve 1400 is then unrolled to the in-use configuration, wherein the sleeve 1400 is snuggly fit around the faucet attachment 1300 and the tub faucet 6000. In some embodiments, a clip 1500 is secured around the sleeve 1400 and the tub faucet 6000 to further secure the sleeve 1400 thereto. The sleeve 1400 forms a watertight seal around the faucet 6000 which allows the water pressure to force water through the hose 1100 and spray head 1200. Without a watertight seal, the pressure within the hose 1100 would decrease water flow through the present invention.

When the tub faucet 6000 is turned on, water flows from the faucet opening through the faucet attachment 1300, hose 1100 and spray head 1200. The sleeve 1400 is configured to prevent any leakage between the faucet attachment and the tub faucet 6000 due to the tightness of the fit of the sleeve and the waterproof material thereof.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A sprayer attachment with faucet sleeve, comprising:
a hose having a spray head at a first end and a faucet attachment disposed at an opposing second end;
wherein the faucet attachment is adapted to secure to a faucet such that the hose is in fluid communication therewith;
a sleeve extending from the second end of the hose, wherein the sleeve is movable between a non-use configuration and an in-use configuration;
wherein the non-use configuration, the sleeve is rolled exposing the faucet attachment;
wherein the in-use configuration the sleeve is unrolled, concealing the faucet attachment and configured to cover a length of the faucet.

2. The sprayer attachment of claim 1, wherein the faucet attachment is configured to secure around an opening of the faucet.

3. The sprayer attachment of claim 1, wherein the faucet attachment is rigid.

4. The sprayer attachment of claim 1, wherein the sleeve is monolithic with the hose.

5. The sprayer attachment of claim 1, wherein the sleeve is flexible and elastic configured to secure around the faucet.

6. The sprayer attachment of claim 1, wherein the sleeve extends beyond a distal end of the faucet attachment in the in-use configuration.

7. The sprayer attachment of claim 1, wherein the sleeve extends beyond a distalmost end of the faucet attachment in the in-use configuration.

8. The sprayer attachment of claim 1, wherein the sleeve is waterproof.

9. The sprayer attachment of claim 1, further comprising a clip configured to secure around the sleeve and the faucet in the in-use configuration.

10. The sprayer attachment of claim 1, wherein the faucet attachment comprises a square cross-sectional shape.

11. The sprayer attachment of claim 1, wherein the faucet attachment comprises a first end extending from the hose and a second end terminating in an opening.

12. The sprayer attachment of claim 11, wherein the second end of the faucet attachment tapers towards the first end.

13. The sprayer attachment of claim 11, wherein the second end comprises a uniform width.

14. The sprayer attachment of claim 11, wherein the first end of the faucet attachment is perpendicular to the second end thereof.

15. The sprayer attachment of claim 1, wherein the sleeve comprises a ring around the hose when in the non-use configuration.
